(19) United States
(12) Patent Application Publication
(10) Pub. No.: US 2005/0167773 A1
(43) Pub. Date: Aug. 4, 2005

(54) Semiconductor element for solid state image sensing device and solid state image sensing device using the same

(75) Inventors: Koji Ozawa, Chiba-shi (JP); Yoichi Miyazawa, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/968,312

(22) Filed: Oct. 20, 2004

(30) Foreign Application Priority Data
Jan. 30, 2004 (JP) P2004-024645

(51) Int. Cl. H04N 5/225

(52) U.S. Cl. 257/433

(57) ABSTRACT

A semiconductor element for solid state image sensing device includes a semiconductor element body (semiconductor chip) in which an image sensing area having an image sensor portion and a connection area having an electrode are provided. A transparent resin layer is joined to the image sensing area of the semiconductor element to cover the image sensing area. An optical sealing plate is joined onto the transparent resin layer. According to the semiconductor element for solid state image sensing device as structured above, downsizing, thickness reduction, and cost reduction of a solid state image sensing device are realized. The solid state image sensing device includes a mounting board to which the semiconductor element for solid state image sensing device is joined.

### CROSS REFERENCE TO RELATED APPLICATIONS

This application is based upon and claims the benefit of priority from the prior Japanese Patent Application No. 2004-24645, filed on Jan. 30, 2004; the entire contents of which are incorporated herein by reference.

### BACKGROUND

1. Field of the Invention

The present invention relates to a semiconductor element for solid state image sensing device and a solid state image sensing device using the same.

2. Description of the Related Art

Solid state image sensing devices are utilized in various kinds of apparatuses such as facsimile machines, scanners, barcode readers, cameras, and VTRs. A CCD image sensing element and a CMOS image sensing element are known as a semiconductor element constituting the solid state image sensing device. A DIP package having a lead frame, an LCC package having a leadless structure, and the like are generally used as packages of these semiconductor elements (solid state image sensing elements). FIG. 7 shows a solid state image sensing device to which a DIP package is applied. FIG. 8 shows a solid state image sensing device to which an LCC package is applied.

In FIG. 7 and FIG. 8, 1 denotes a solid state image sensing element. The solid state image sensing element 1 shown in FIG. 7 is joined to a package base 3 having a lead frame 2. The solid state image sensing element 1 shown in FIG. 8 is joined to a package base 5 having connection terminals 4 formed on an outer peripheral face. A frame 6 is joined to an outer periphery of an upper face of each of the package bases 3, 5. An optical sealing plate 7 made of a glass plate or the like is joined to the frame 6 so as to seal each of the solid state image sensing elements. Such conventional solid state image sensing devices require the package bases 3, 5 and the frames 6 forming sealed spaces 8 of the solid state image sensing elements 1. Therefore, the production cost and part cost increase, and it is difficult to realize downsized and thin solid state image sensing devices.

In view of the above respect, Japanese Patent Laid-Open Application No. 2003-332542 describes a package structure in which a sealing resin layer in a frame shape is formed to surround a solid state image sensing element and a transparent substrate is bonded to this sealing resin layer in a frame shape. U.S. Pat. No. 6,472,761 describes a package structure in which a projecting electrode formed on a solid state image sensing element and an electrode terminal formed on a transparent substrate are joined together to form a space between the solid state image sensing element and the transparent substrate. A printed wiring board in a frame shape having connection terminals is joined to an outer periphery of the transparent substrate and the printed wiring board supports the transparent substrate. These solid state image sensing devices also require a sealing space for the solid state image sensing element. Therefore, similarly to the aforesaid DIP package and LCC package, it is difficult to realize a thin and downsized package.

Japanese Patent Laid-Open Application No. 2001-516956 describes a package structure in which a frame-shaped resin layer is formed on an outer periphery of an upper face of a package base to which a solid state image sensing element and so on are joined and a transparent adhesive material is filled in a cavity formed by this frame-shaped resin layer. In such a package structure, the transparent adhesive material in liquid form filled in the cavity is cured to seal the solid state image sensing element, which has a problem of easy generation of bubbles in the transparent adhesive material being a sealing material. The bubbles generated in the sealing material of the solid state image sensing element will be a cause of deterioration in optical properties. Further, since the solid state image sensing element is sealed after it is mounted on a package base, there arises a problem that foreign objects and the like adhere to a light receiving portion of the solid state image sensing element during a step of handling the solid state image sensing element and a package assembly step, so that defects tend to occur. The size of the solid state image sensing device is also influenced by the shape of the package base.

In a solid state image sensing device including a solid state image sensing element mounted on a package base having a lead frame and so on, further proposed is a structure in which a transparent substrate is bonded to a light receiving face of the solid state image sensing element via liquid transparent adhesive or gelatinous transparent resin (see, for example, Japanese Patent Laid-Open Application No. Hei 5-183138 and U.S. Pat. No. 6,121,675). In these package structures, bubbles also tend to be generated in an adhesive layer or a filled layer due to a step of applying the liquid transparent adhesive or a step of filling the gelatinous transparent resin. Moreover, in both of the solid state image sensing devices, the solid state image sensing element is sealed after it is mounted on the package base, so that foreign objects and the like tend to adhere to the light receiving portion of the solid state image sensing element. In addition, the use of the package base having the lead frame and so on makes it difficult to realize a downsized solid state image sensing device.

Japanese Patent Laid-Open Application No. Hei 4-114456 describes a structure in which a solid state image sensing element is directly mounted on a circuit board and a glass substrate is bonded to a light receiving face of such a solid state image sensing element using transparent adhesive. This structure can prevent the increase in size of a device caused by a package base, but on the other hand, has a problem that foreign objects and the like tend to adhere to the light receiving portion of the solid state image sensing element when the solid state image sensing element is mounted on the circuit board. The adhesion of the foreign objects to the light receiving portion will be a cause of defects. Moreover, the generation of bubbles due to a step of applying the transparent adhesive and the deterioration in optical properties due to the bubbles also occur similarly to the aforesaid devices in which the solid state image sensing element is mounted on the package base.

As described above, in the conventional solid state image sensing devices, since the solid state image sensing element is sealed using the package structure, it is difficult to realize a downsized and thin device. In addition, foreign objects and the like adhere to the light receiving portion during the step of handling the solid state image sensing element and the package assembly step, so that defects tend to occur. Further, the structure of sealing the solid state image sensing element with the transparent resin and the structure of bonding the transparent substrate to the light receiving face of the solid state image sensing element using the transparent adhesive or the gelatinous transparent resin in the prior art have a problem that bubbles tend to be generated in the adhesive layer or the filled layer due to the step of filling the transparent resin or the step of applying the transparent adhesive. The bubbles generated in the adhesive layer or the filled layer will cause deterioration in optical properties.

It is an object of the present invention to provide a semiconductor element for solid state image sensing device that can realize a downsized and thin solid state image p sensing device and to a solid state image sensing device using such a semiconductor element.

### SUMMARY

A semiconductor element for solid state image sensing device according to one of the aspects of the present invention includes: a semiconductor element body including an image sensing area having an image sensor portion and a connection area having an electrode; a transparent resin layer joined to the semiconductor element body to cover the image sensing area; and an optical sealing plate joined onto the transparent resin layer.

A solid state image sensing device according to another aspect of the present invention includes: a semiconductor element including an element body having an image sensing area and a connection area, a transparent resin layer joined to the element body to cover the image sensing area, and an optical sealing plate joined onto the transparent resin layer; and a mounting board having an external connection terminal electrically connected to the semiconductor element, the semiconductor element being joined to the mounting board.

### BRIEF DESCRIPTION OF THE DRAWINGS

The present invention will be described with reference to the drawings, but these drawings are presented only for an illustrative purpose and in no respect, are to limit the present invention.

FIG. 1 is a plane view schematically showing the structure of a semiconductor element for solid state image sensing device according to an embodiment of the present invention.

FIG. 2 is a cross sectional view taken along the X-X line in FIG. 1.

FIG. 3 is a cross sectional view taken along the Y-Y line in FIG. 1.

FIG. 4 is a plane view schematically showing the structure of a solid state image sensing device according to an embodiment of the present invention.

FIG. 5 is a cross sectional view taken along the X-X line in FIG. 4.

FIG. 6 is a cross sectional view taken along the Y-Y line in FIG. 4.

FIG. 7 is a cross sectional view showing an example of the structure of a solid state image sensing device to which a conventional DIP package is applied.

FIG. 8 is a cross sectional view showing an example of the structure of a solid state image sensing device to which a conventional LCC package is applied.

### DETAILED DESCRIPTION

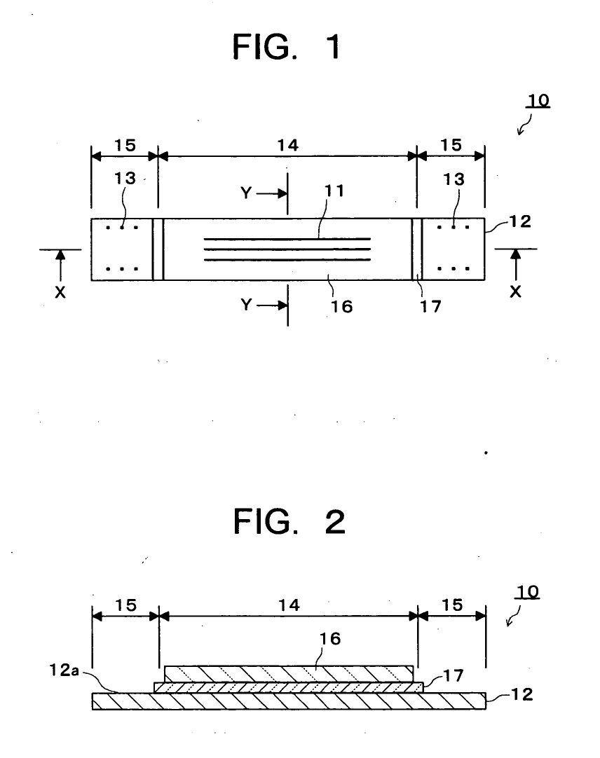

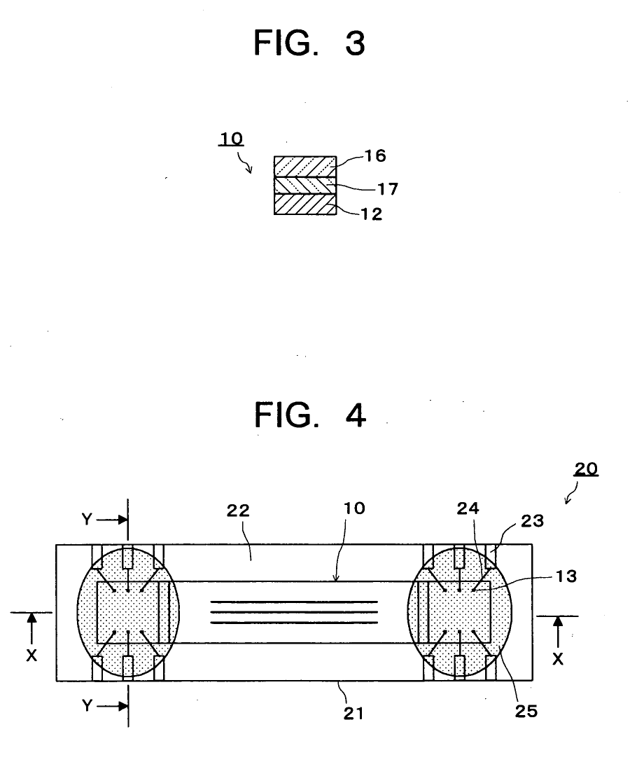

Embodiments of the present invention will be hereinafter explained with reference to the drawings. FIG. 1, FIG. 2, and FIG. 3 are views schematically showing the structure of a semiconductor element for solid state image sensing device according to an embodiment of the present invention. FIG. 1 is a plane view of the semiconductor element for solid state image sensing device according to the embodiment, FIG. 2 is a cross sectional view taken along the X-X line in FIG. 1, and FIG. 3 is a cross sectional view taken along the Y-Y line in FIG. 1.

A semiconductor element 10 for solid sate image sensing device shown in these drawings has a semiconductor element body (semiconductor chip) 12 having an image sensor portion (light receiving portion) 11 on one main surface side. Electrodes 13, 13 are provided on both end sides of the semiconductor element body 12 respectively. The image sensor portion 11 and the electrodes 13 are formed on the same surface 12a of the semiconductor element body 12. An area having the image sensor portion 11 constitutes an image sensing area 14. Further, areas on both end sides having the electrodes 13, 13 constitute connection areas 15, 15 respectively.

For example, a CCD image sensing element, a CMOS image sensing element, or the like is used as the semiconductor element body 12. However, the semiconductor element body 12 is not limited to these solid state image sensing element, but various kinds of solid state image sensing elements that are structured such that a semiconductor light receiving portion and a scan portion are integrally formed in a semiconductor chip are applicable. FIG. 1 to FIG. 3 show the semiconductor element 10 that is intended for a linear sensor, and the image sensor portion 11 is formed along a longitudinal direction of the semiconductor element body 12. The electrodes 13, 13 are disposed outside both ends of the image sensor portion 11. The semiconductor element body 12 is a solid state image sensing element for linear sensor.

An optical sealing plate 16 is disposed on the surface 12a having the image sensor portion 11 of the semiconductor element body 12 to cover the image sensing area 14. The optical sealing plate 16 is joined to the semiconductor element body 12 via a transparent resin layer 17. To be more specific, the transparent resin layer 17 is joined to the semiconductor element body 12 to cover the image sensing area 14, and the optical sealing plate 16 is joined onto the transparent resin layer 17. The image sensing area 14 is sealed with the transparent resin layer 17 and the optical sealing plate 16. The connection areas 15 of the semiconductor element body 12 are not covered with the optical sealing plate 16 but exposed to the outside to facilitate electrical connection.

The semiconductor element 10 for solid state image sensing device itself has a function of sealing and protecting the image sensor portion 11. In other words, the semiconductor element 10 has a package function, and therefore, unlike conventional solid state image sensing devices, it is not necessary to use a package structure such as a DIP package, an LCC package, or the like for sealing. The transparent resin layer 17 has a function of sealing the image sensor portion 11 and a function of bonding the optical sealing plate 16 to the image sensing area 14 of the semiconductor element body 12. The optical sealing plate 16 has a function of sealing the image sensor portion 11, a function of protecting the transparent resin layer 17, and a function of maintaining planarity of a final element surface.

As the optical sealing plate 16, various kinds of light transmissive substrates are applicable, as long as they are plate members made of materials having a light transmittance property. Specific examples of the optical sealing plate 16 are a glass substrate, a resin substrate made of transparent resin such as acryl resin, and the like. The thickness of the optical sealing plate 16 is not limited to a specific value, but in view of a light transmittance property, functions as a sealing plate, and so on, it is preferably within a range of 0.1 mm to 1.2 mm. As the optical sealing plate 16, usable are: a substrate whose surface is coated with an optical thin film such as an IR (infrared ray) cut film or an AR coat (antireflection film); a substrate having an intermediate film inclusive of an IR cut material, an anti reflection material, or the like; and so forth.

The transparent resin layer 17 is preferably a resin layer containing substantially no bubble in order to prevent scattering, refraction, and the like of light incident on the image sensor portion 11. If the transparent resin layer 17 contains bubbles, light gathering properties, image sensing properties, and so on of the semiconductor element body 12 as a solid state image sensing element are deteriorated. Such a transparent resin layer 17 containing substantially no bubble can be obtained by, for example, the use of an adhesive transparent resin sheet for bonding the semiconductor element body 12 and the optical sealing plate 16 to each other. The adhesive transparent resin sheet is made of an adhesive transparent resin composition molded in a sheet form, and its curing reaction is promoted when it is left under room temperature or is heated, so that it functions as an adhesive layer. The adhesive transparent resin composition when molded may be in a cured state to a degree large enough to maintain the sheet form (for example, in a cross-linked state).

In order to bond the semiconductor element body 12 and the optical sealing plate 16 to each other, the adhesive transparent resin sheet is first put therebetween. This layered object is left under room temperature or heated while an appropriate pressure is being given thereto as required. The heating temperature is selected according to the transparent resin composition, and preferably, it is heated at a temperature range of 50° C. to 200° C. when, for example, a silicone composition is applied. The curing reaction of the adhesive transparent resin sheet is promoted by such a process, so that the semiconductor element body 12 and the optical sealing plate 16 are bonded to each other by the cured adhesive transparent resin sheet.

The adhesive transparent resin sheet in its cured state exhibits a good adhesive strength. In this case, the transparent resin layer 17 is made of the cured adhesive transparent resin sheet. Incidentally, if the adhesive transparent resin sheet in its uncured state can exhibit a satisfactory adhesive strength, the transparent resin layer 17 may be formed by the adhesive transparent resin sheet as it is. When the transparent resin layer 17 is thus formed using the adhesive transparent resin sheet made of the adhesive transparent resin composition that is molded in a sheet form in advance, air inclusion, which occurs in the use of liquid transparent adhesive and gelatinous transparent resin, does not occur, so that the transparent resin layer 17 including substantially no bubble can be obtained with good reproducibility.

Moreover, unlike the liquid adhesive, when the adhesive transparent resin sheet is used, no coating unevenness, unnecessary spread thereof, or the like occurs, which enables the transparent resin layer 17 to stably maintain its shape. For example, the outer dimension of the transparent resin layer 17 can be kept fixed. This will contribute to downsizing of the semiconductor element 10. Further, the thickness of the transparent resin layer 17 can be made uniform. This will contribute not only to thickness reduction of the semiconductor element 10 but also to improvement in parallelism of the optical sealing plate 16, and so on. Low parallelism and flatness of the optical sealing plate 16 will deteriorate light gathering properties, image sensing properties, and so on of the semiconductor element body 12 as a solid state image sensing element.

As the resin composition forming the adhesive transparent resin sheet, various kinds of resin compositions having transparency and adhesiveness are applicable. As the adhesive transparent resin composition, for example, a silicone resin composition, an epoxy resin composition, a phenol resin composition, or the like is used. The use of the silicone resin composition among these compositions is especially preferable in view of light transmittance properties, a refractive index, and the like. The silicone resin composition contains, for example, polyorganosiloxane and a cross-linking agent as essential components, and further contains a cross-linkage accelerator, an adhesion accelerator, and the like when necessary.

The silicone composition is roughly classified into a condensation curing type silicone composition, a peroxide curing type silicone composition, and a hydrosilylation curing type silicone composition depending on its curing (linkage) mechanism. Any of these silicone compositions is applicable to the adhesive transparent resin sheet, but the application of the hydrosilylation curing type silicone composition is especially preferable because it cures uniformly and quickly without generating any byproduct. The adhesive transparent resin sheet is obtainable in a manner such that, for example, the hydrosilylation curing type silicone composition is molded in a sheet form, and thereafter, it is left under room temperature, heated, irradiated with an electron beam, or the like to be appropriately cross-linked.

The thickness of the aforesaid transparent resin layer 17 made of the cured adhesive transparent resin sheet or the like, though different depending on its light transmittance, refractive index, and the like, is preferably in a range of, for example, 50 μm to 200 μm. The thickness of the transparent resin layer 17 exceeding 200 μm causes deterioration in light transmittance properties and so on, resulting in deterioration in light gathering properties, image sensing properties, and soon of the semiconductor element body 12 as a solid state image sensing element. On the other hand, if the thickness of the transparent resin layer 17 is less than 50 μm, the surface with irregularities in the image sensing area 14 of the semiconductor element body 12 may not be sufficiently filled. Consequently, bubbles tend to be generated on a junction interface. The transparent resin layer 17 with a desired thickness can be obtained by the use of the adhesive transparent resin sheet having substantially equal thickness to the desired thickness since thickness change from the adhesive transparent resin sheet to the transparent resin layer 17 is only a little.

The transparent resin layer 17 preferably has an outer dimension larger than that of the optical sealing plate 16 in view of enhancing reliability in adhesion between the semiconductor element body 12 and the optical sealing plate 16. In the semiconductor element 10 shown in FIG. 1 to FIG. 3, the outer dimension of the transparent resin layer 17 is slightly larger than that of the optical sealing plate 16 in a forming direction (longitudinal direction) of the image sensor portion 11. The outer dimension of the transparent resin layer 17 and that of the optical sealing plate 16 are substantially equal in a width direction of the semiconductor element 10 as shown in FIG. 3. The application of such a structure makes it possible to enhance reliability in adhesion between the semiconductor element body 12 and the optical sealing plate 16 without deteriorating a sealed state of the image sensor portion 11. Incidentally, if the outer dimension of the semiconductor element body 12 has an allowance, the shape of an entire outer periphery of the transparent resin layer 17 may be made larger than that of the optical sealing plate 16.

In the semiconductor element 10 for solid state image sensing device in this embodiment, the semiconductor element body (solid state image sensing element) 12 itself, which have the image sensor portion 11, is imparted a sealing and a protecting function (package function) for the image sensor portion 11. This makes it possible to inhibit the occurrence of defects caused by the adhesion or the like of foreign objects to the image sensor portion 11 when the semiconductor element 10 is mounted or handled. For example, when the semiconductor element 10 for solid state image sensing device is supplied to a device maker in a chip state, foreign objects and so on may possibly adhere to the surface of the light receiving portion during its transportation. On the other hand, owing to the protection of the image sensor portion 11 by the optical sealing plate 16, the semiconductor element 10 for solid state image sensing device can be supplied to a device maker substantially in a chip state. Moreover, the package function imparted to the semiconductor element 10 itself is realized by the simple structure in which the optical sealing plate 16 is joined to the semiconductor element body 12 via the transparent resin layer 17. Consequently, it is possible to realize downsizing and thickness reduction of the semiconductor element 10 for solid state image sensing device having the package function, and to inhibit increase in part cost and production cost.

Further, the use of, for example, the adhesive transparent resin sheet can bring the transparent resin layer 17 constituting the package structure into a state including substantially no bubble. The adhesive transparent resin sheet can stably maintain its shape after the adhesion (after the curing). Specifically, the outer dimension and thickness of the transparent resin layer 17 made of the adhesive transparent resin sheet or the cured adhesive transparent resin sheet can be kept fixed. The uniform thickness of the transparent resin layer 17 enables enhancement in optical parallelism and flatness of the optical sealing plate 16. These factors make it possible to inhibit deterioration in light gathering properties, image sensing properties, and so on of the semiconductor element body 12 as a solid state image sensing element. Thus it is possible to realize downsizing and thickness reduction of the semiconductor element 10 having the package function, reduction in part cost and production cost, and so on without any deterioration in properties of the semiconductor element body 12.

It should be noted that, though the explanation of the above embodiment gives the case where the semiconductor element for solid state image sensing device of the present invention is applied to the semiconductor element 10 for linear sensor, the present invention is not limited to this. The semiconductor element for solid state image sensing device of the present invention is applicable to a semiconductor element for area sensor. However, the semiconductor element for area sensor has a microlens formed on a color filter, and if the transparent resin layer 17 is formed thereon, a refractive index of transparent resin needs to be adjusted. On the other hand, since the semiconductor element for linear sensor does not generally have a microlens formed on a color filter, the optical sealing plate 16 can be joined relatively easily with low cost transparent resin. From these viewpoints, the present invention is suitable for the semiconductor element 10 for linear sensor.

The semiconductor element 10 for solid state image sensing device of the above-described embodiment is mounted on a mounting board for use as a solid state image sensing device as will be detailed later. However, since the semiconductor element 10 itself has the package function, it is also possible to mount the semiconductor element 10 directly on a circuit board of an optical device. When such a chip-on-board structure is applied, the electrodes 13 of the semiconductor element 10 and wirings of the circuit board are electrically connected to each other by bonding wires after the semiconductor element 10 is mounted on the circuit board. The electrodes of the semiconductor element 10 may be formed of metal bumps such as solder bumps. The use of such projecting electrodes can enhance mountability of the semiconductor element 10 onto the circuit board. The metal bumps are applicable not only to a chip-on-board structure but also to a case where the semiconductor element 10 is mounted on a typical mounting board.

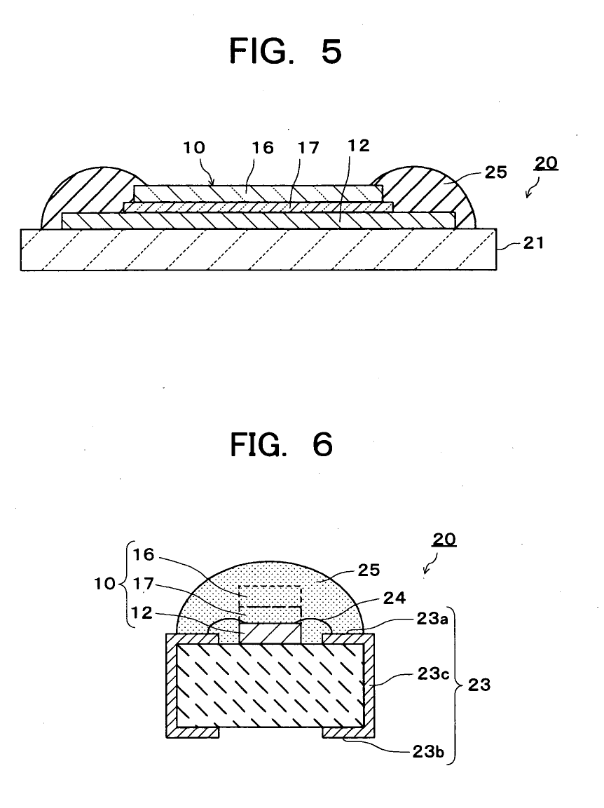

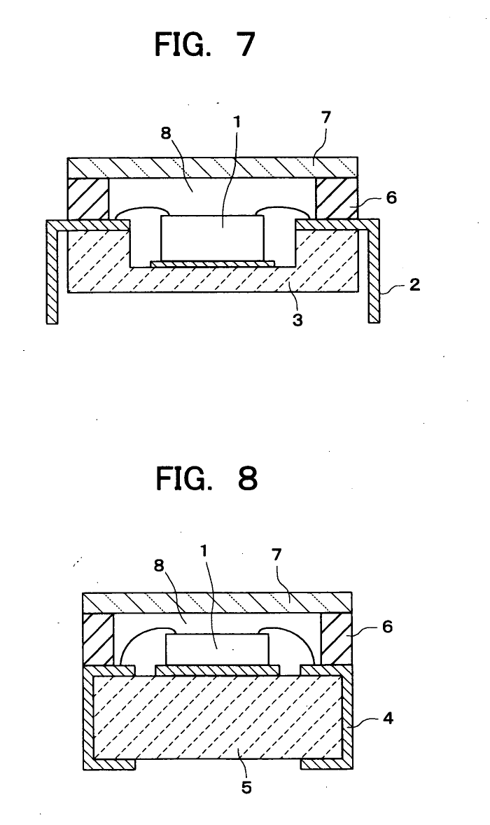

Next, an embodiment of the solid state image sensing device of the present invention will be explained with reference to FIG. 4, FIG. 5, and FIG. 6. FIG. 4 to FIG. 6 are views schematically showing the structure of a solid state image sensing device according to an embodiment of the present invention. FIG. 4 is a plane view of the solid state image sensing device according to the embodiment, FIG. 5 is a cross sectional view taken along the X-X line in FIG. 4, and FIG. 6 is a cross sectional view taken along the Y-Y line in FIG. 4. A solid state image sensing device 20 shown in these drawings includes the semiconductor element 10 for solid state image sensing device according to the above-described embodiment and a mounting board 21 on which the semiconductor element 10 is mounted. The structure of the semiconductor element 10 for solid state image sensing device is the same as that described in the above-described embodiment.

The mounting board 21 is formed of an insulative board such as, for example, a ceramic board and a resin board. Such a mounting board 21 has a junction face (upper face) 22 on which the semiconductor element 10 is die-bonded and non-pin type lead terminals 23 which are to serve as external connection terminals. The lead terminals 23 are disposed on both end sides of the mounting board 21 so as to correspond to the electrodes 13, 13 of the semiconductor element 10. The mounting board 21 having the non-pin type lead terminals 23 has a so-called LCC structure. Specifically, each of the non-pin type lead terminals 23 is structured such that an electrode portion 23a on an upper face side of the mounting board 21 and a connection terminal portion 23b on a lower face side thereof are connected by a conductor layer 23c on a side face portion thereof, which enables surface mount of the mounting board 21 itself.

A board on which the semiconductor element 10 is mounted is not limited to the mounting board with the LCC structure as described above. The semiconductor element 10 may be mounted on a typical printed wiring board or the like. Further, for example, when the number of electrodes is large, the semiconductor element 10 may be mounted on a wiring board with a BGA structure having metal bumps and soon. Thus, the structure, shape, constituent materials, and so on of the mounting board are not limited to specific ones. However, the semiconductor element 10 is preferably joined onto a board that itself can be surface-mounted.

The semiconductor element 10 for solid state image sensing device is joined to the junction face 22 of the mounting board 21, using, for example, a die-bonding film. Further, the electrodes 13 of the semiconductor element 10 are electrically connected to the lead terminals 23 (to be more specific, the electrode portions 23a) of the mounting board 21 via bonding wires 24. The bonding wires 24 are covered with sealing resin 25 made of, for example, epoxy resin, phenol resin, or the like.. The sealing resin 25 is intended for preventing electrical and mechanical deterioration of the boding wires 24 and connecting portions thereof, and the use of sealing resin with enhanced heat release properties is preferable. It should be noted that the connection structure of the semiconductor element 10 is not limited to wire bonding, and, for example, flipchip bonding is applicable.

In the solid state image sensing device 20 of this embodiment, owing to the package function that the semiconductor element 10 itself has, it is not necessary to provide a package structure on the board 21 on which the semiconductor element 10 is mounted. This enables great reduction in part cost of the mounting board 21. Further, the mounting board 21 can be downsized according to the shape of the semiconductor element 10. The semiconductor element 10 that itself is made compact and thin is mounted on such a mounting board 21 to constitute the solid state image sensing device 20. Consequently, it is possible to realize downsizing and thickness reduction of the solid state image sensing device 20, and moreover, achieve reduction in production cost and part cost. According to this embodiment, the solid state image sensing device 20 that is made compact and thin and whose cost is reduced can be provided.

It should be noted that the present invention is not to be limited to the specific forms described here with illustration, but is applicable to various kinds of solid state image sensing elements and solid state image sensing devices using the same. It is to be understood that all changes and modifications within the range of the following claims are embraced in the present invention, and such solid state image sensing elements and solid state image sensing devices using the same are also included in the present invention.

1. A semiconductor element for solid state image sensing device, comprising:
a semiconductor element body including an image sensing area having an image sensor portion and a connection area having an electrode;
a transparent resin layer joined to said semiconductor element body to cover the image sensing area; and
an optical sealing plate joined onto said transparent resin layer.

2. A semiconductor element for solid state image sensing device as set forth in claim 1,
wherein said transparent resin layer contains substantially no bubble.

3. A semiconductor element for solid state image sensing device as set forth in claim 1,
wherein said transparent resin layer has one of an adhesive transparent resin sheet and a cured adhesive transparent resin sheet.

4. A semiconductor element for solid state image sensing device as set forth in claim 3,
wherein the adhesive transparent resin sheet is made of a silicone resin sheet.

5. A semiconductor element for solid state image sensing device as set forth in claim 1,
wherein the image sensing area and the connection area are formed on a same face of said semiconductor element body, and said transparent resin layer and said optical sealing plate cover only the image sensing area.

6. A semiconductor element for solid state image sensing device as set forth in claim 1,
wherein said transparent resin layer has a larger outer dimension than an outer dimension of said optical sealing plate.

7. A semiconductor element for solid state image sensing device as set forth in claim 1,
wherein said transparent resin layer has a thickness in a range of 50 μm to 200 μm, and said optical sealing plate has a thickness in a range of 0.1 mm to 1.2 mm.

8. A semiconductor element for solid state image sensing device as set forth in claim 1,
wherein said semiconductor element body has one of a CCD image sensing element and a CMOS image sensing element.

9. A semiconductor element for solid state image sensing device as set forth in claim 1,
wherein said semiconductor element body has a solid state image sensing element for linear sensor.

10. A solid state image sensing device comprising:
a semiconductor element comprising an element body having an image sensing area and a connection area, a transparent resin layer joined to the element body to cover the image sensing area, and an optical sealing plate joined onto the transparent resin layer; and
a mounting board having an external connection terminal electrically connected to said semiconductor element, said semiconductor element being joined to the mounting board.

11. A solid state image sensing device as set forth in claim 10,
wherein the transparent resin layer contains substantially no bubble.

12. A solid state image sensing device as set forth in claim 10,
wherein the transparent resin layer has one of an adhesive transparent resin sheet and a cured adhesive transparent resin sheet.

13. A solid state image sensing device as set forth in claim 12,
wherein the adhesive transparent resin sheet is made of a silicone resin sheet.

14. A solid state image sensing device as set forth in claim 10,
wherein the external connection terminal of said mounting board is electrically connected to an electrode of said semiconductor element via a bonding wire and the bonding wire is sealed with sealing resin.

15. A solid state image sensing device as set forth in claim 10,
wherein said mounting board has a surface mount structure.

16. A solid state image sensing device as set forth in claim 10,
wherein said solid state image sensing device is a linear sensor.
